(19) United States
(12) Patent Application Publication
(10) Pub. No.: US 2018/0101219 A1
(43) Pub. Date: Apr. 12, 2018

(54) PREVENTING POWER GATING OF A DOMAIN

(71) Applicant: Microsoft Technology Licensing, LLC, Redmond, WA (US)

(72) Inventors: Jonathan Ross, Woodinville, WA (US); Robert Allen Shearer, Woodinville, WA (US); Jay Tsao, Kirkland, WA (US)

(21) Appl. No.: 15/287,578

(22) Filed: Oct. 6, 2016

(51) Int. Cl. G06F 1/32

(52) U.S. Cl. CPC G06F 1/3287; G06F 1/3206

(57) ABSTRACT

A counter is maintained for power domains that can be powered-off or deactivated. When this counter is non-zero, the corresponding power domain is not powered-off, even if it is idle. Other agents (e.g., circuits or software running in other power domains) can write to an address that increments the counter, and to another address that decrements the counter. When an agent wants another power domain to remain powered-up (e.g., because that agent is about to use or communicate with the target power domain), it increments the count. When the agent no longer needs the target power domain to remain on, it decrements the count. Thus, as long as the count is non-zero, the target domain is maintained in an active (e.g. on) state. When the count reaches zero, it indicates that no agents need the target domain to remain active and therefore the target domain can be powered-off.

### BACKGROUND

To reduce the power consumption of an integrated circuit, the circuits (i.e., blocks, logic, etc.) of a chip may be divided into multiple clock domains and/or multiple power domains. The multiple domains allow for the switching off of local power supplies to eliminate leakage current and the dynamic scaling of voltages and clock frequencies to reduce operating current. Typically, a power manager circuit functions to power-down and power-up these multiple domains according to the current activity of a corresponding power domain.

### SUMMARY

Examples discussed herein relate to an integrated circuit that includes a plurality of electronic components organized as at least two power domains. The at least two power domains include a first power domain and a second power domain. The integrated circuit also includes a power management unit to, based on a first indicator received from the second power domain, maintain the first power domain in a powered-up state.

In an example, an integrated circuit includes a plurality of electronic logic blocks organized into at least three power domains. These power domains include a first power domain, a second power domain, and a master power domain. The integrated circuit also includes a power management unit that is part of the master power domain. This power management unit to maintains a value that changes, in a first way (e.g., increments), in response to a first plurality of accesses by the first power domain. The value also changes, in a second way (e.g. decrements), in response to a second plurality of accesses by the first power domain. The power management unit maintains the second power domain in a powered-up state based at least in part on the value meeting a threshold criteria (e.g., non-zero.)

In an example, a computer is instructed to access a first address that results in an equivalent of incrementing a counter. The computer is also instructed to access a second address that results in an equivalent of decrementing the counter. A value of the counter is used to determine whether a first power domain of a plurality of power domains is to be maintained in a powered-up state.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 is a block diagram of an integrated circuit.

FIGS. 2A-2E illustrate an integrated circuit with multiple power domains that are maintained powered-up based on indicators from other power domains.

FIG. 3 is a flowchart illustrating a method of maintaining a power domain in a powered-up state.

FIG. 4 is a flowchart illustrating a method of activating and deactivating a power domain.

FIG. 5 is a flowchart illustrating a method of allowing a power domain to be deactivated.

FIG. 6 is a flowchart illustrating a method of keeping a power domain active.

FIG. 7 is a block diagram of a computer system.

### DETAILED DESCRIPTION OF THE EMBODIMENTS

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a computing device, or an integrated circuit.

Various sub-circuits or blocks (e.g., processors, network interfaces, etc.) of an integrated circuit may be divided into multiple power domains that can be powered-up and powered-down independently of the other power domains. These power domains are typically powered-down to reduce power consumption and heat generation while the circuits inside of them are not being used.

In an embodiment, a counter is maintained for power domains that can be powered-off or deactivated. Based at least in part on this counter being non-zero, the power domain is not powered-off, even if it is idle. Other agents (e.g., circuits or software running in other power domains) can write to an address that increments the counter, and to another address that decrements the counter. When an agent wants another power domain to remain powered-up (e.g., because that agent is about to use or communicate with the target power domain), it increments the count. When the agent no longer needs the target power domain to remain on, it decrements the count. Thus, as long as the count is non-zero, the target domain is maintained in an active (e.g., on) state. If the count reaches zero, it indicates that no agents need the target domain to remain active and therefore the target domain can be powered-off.

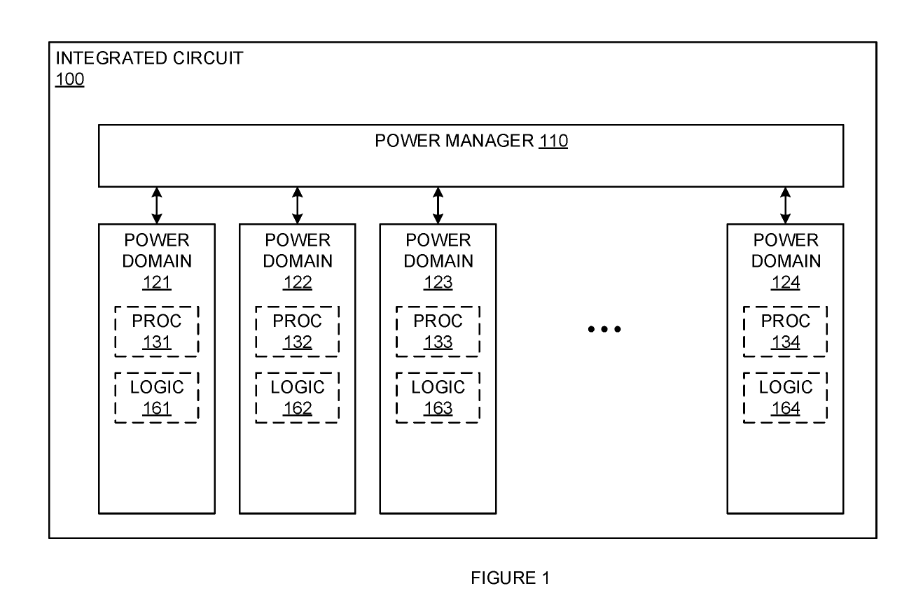

FIG. 1 is a block diagram of an integrated circuit. Integrated circuit 100 is a type of devices, such as is commonly referred to as a “chip”. For example, integrated circuit 100 may be or include a microprocessor, a multi-core processor, a system-on-a-chip (SoC), a memory controller, a memory, a northbridge chip, an application specific integrated circuit (ASIC) device, and/or a graphics processor unit (GPU). Integrated circuit 100 may be a device that includes many circuit/logic blocks such as ones selected from graphics cores, processor cores, MPEG encoder/decoders, networking (e.g., Ethernet), and wireless (e.g., Wi-Fi), etc.

As used herein, the term “processor” includes digital logic that executes operational instructions to perform a sequence of tasks. The instructions can be stored in firmware or software, and can represent anywhere from a very limited to a very general instruction set. A processor can be one of several “cores” (a.k.a., ‘core processors’) that are co-located on a common die or integrated circuit (IC) with other processors. In a multiple processor (“multi-processor”) system, individual processors can be the same as or different than other processors, with potentially different performance characteristics (e.g., operating speed, heat dissipation, cache sizes, pin assignments, functional capabilities, and so forth). A set of “asymmetric” or “heterogeneous” processors refers to a set of two or more processors, where at least two processors in the set have different performance capabilities (or benchmark data). A set of “symmetric” or “homogeneous” processors refers to a set of two or more processors, where all of the processors in the set have the same performance capabilities (or benchmark data). As used in the claims below, and in the other parts of this disclosure, the terms “processor”, “processor core”, and “core processor”, or simply “core” will generally be used interchangeably.

In FIG. 1, integrated circuit 100 includes power manager 110, power domain 121, power domain 122, power domain 123, and power domain 124. Power domain 121 may include processor 131 and/or logic circuitry 161. Power domain 122 may include processor 132 and/or logic circuitry 162. Power domain 123 may include processor 133 and/or logic circuitry 163. Power domain 124 may include processor 134 and/or logic circuitry 164. Integrated circuit 100 may include additional power domains that are not shown in FIG. 1. Integrated circuit 100 may include a master power domain that includes circuitry that is not to be powered-down. In an example, a master power domain may include power manager 110. Power manager 110 is operatively coupled to power domains 121-124.

Power manager 110 may be or include logic circuitry to implement a finite state machine to perform the functions described herein. Power manager 110 may include software, field-programmable gate array (FPGA) hardware, memory, and/or at least one microprocessor core to implement the functions of power manager 110 using one or more finite state machines. Power manager 110 may be specified by a software description of its functionality. This software description may be translated or compiled into the logic circuitry, software, and/or hardware descriptions that implement the functionality of power manager 110. Software descriptions that describe power manager 110 may be or include: firmware, behavioral, register transfer, logic component, transistor, and layout geometry-level descriptions.

Power manager 110 may be configured to manage power delivery to some or all of the functional blocks included in integrated circuit 100. In particular, power manager 110 may be configured to manage power delivery to multiple power domains 121-124. Power manager 110 may include blocks for managing multiple power supplies for various power domains 121-124. In various embodiments, the power supplies provided to power domains 121-124 may originate external to integrated circuit 100 and are coupled to IC 100 via one or more power supply pins (not shown in FIG. 1.) Power manager 110 may receive signals that indicate the operational state (e.g., busy, idle, etc.) of one or more functional blocks within power domains 121-124. Based on these signals, power manager 110 may power-down and power-up respective power domains 121-124.

In an embodiment, power manager 110 is operatively coupled to power domains 121-124 in order to power-up and power-down (or otherwise activate and deactivate) power domains 121-124. Power manager 110 may receive, from a power domain 121-124 a signal, message, request, or other indicator that communicates to power manager 110 that the requesting power domain 121-124 desires that a particular power domain 121-124 be kept powered-up or otherwise kept active. For example, processor 131 in power domain 131 may signal power manager 110 that power domain 132 should be kept powered-up. In another example, processor 131 in power domain 131 may signal power manager 110 that power domain 131 itself should be kept powered-up.

Likewise, power manager 110 may receive, from a power domain 121-124 a signal, message, request, or other indicator that communicates to power manager 110 that the requesting power domain 121-124 desires that a particular power domain 121-124 be allowed to be powered-down or otherwise be allowed to be deactivated. For example, processor 131 in power domain 131 may signal power manager 110 that power domain 132 may (at least as far as power domain 132 is concerned) be allowed to be powered-down (optionally as a result of additional conditions being met). In another example, processor 131 in power domain 131 may signal power manager 110 that power domain 131 itself should be allowed to be powered-down.

Power manager 110 may include a shared register accessed by multiple agents in power domains 121-124 that is used to keep a corresponding power domain 121-124 powered on even if that domain 121-124 is idle, requests to be powered-off, or otherwise meets a set of conditions for being powered-down. When a domain 121-124 meets a set of conditions for being powered-down to save power, other components in IC 100 may want to keep that domain 121-124 powered on because, for example, of a shared resource that is needed, or because the other component knows a priori that it will need resources from the domain 121-124 within a specified period of time and therefore wants to avoid power-on delays required to re-activate or power-up the domain 121-124.

In an embodiment, power manager 110 includes a counter for each power domain 121-124. This counter is part of, or operatively coupled to a power management state machine (not shown in FIG. 1.) Based on the counter for a corresponding domain 121-124 being effectively non-zero, power manager 110 does not powered-off that domain 121-124 even if it is idle (or otherwise meets a criteria for being powered-off) Based on the counter being effectively zero, power manager 110 may power-down the corresponding power domain 121-124 (optionally as a result of additional power-down conditions being met—e.g., expiration of an idle timer.)

Other agents in the system (i.e., circuitry in power domains 121-124) can write a register in power manager 110 to increment the count and another register in power manager 121-124 to decrement the count. By splitting the programming interface into separate registers, shared write access by multiple agents works without one agent overwriting another agent. When an agent wants the power domain to remain powered on, it increments the count. When the agent no longer needs the domain to remain on, it decrements the count. Based on the count reaching zero (or meeting an equivalent threshold criteria—e.g., the count reaches a predetermined value), the power domain may be (but is not necessarily) powered-down.

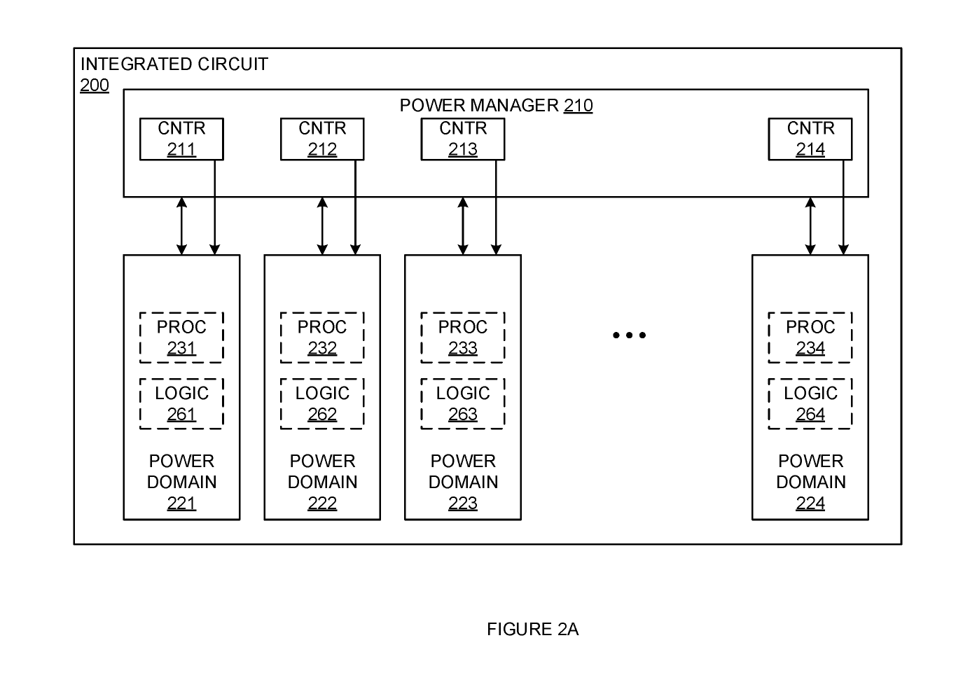

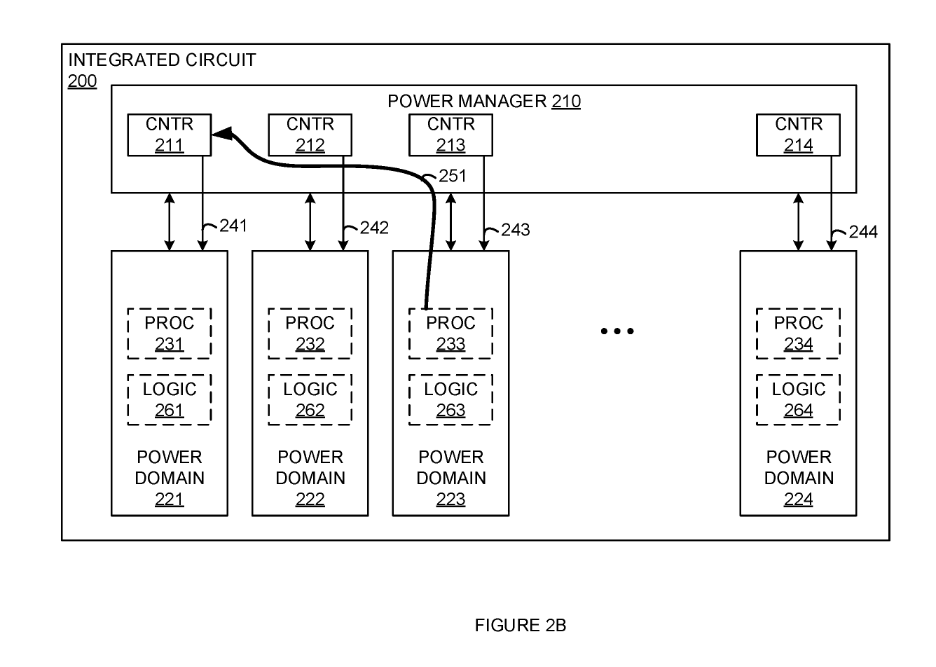

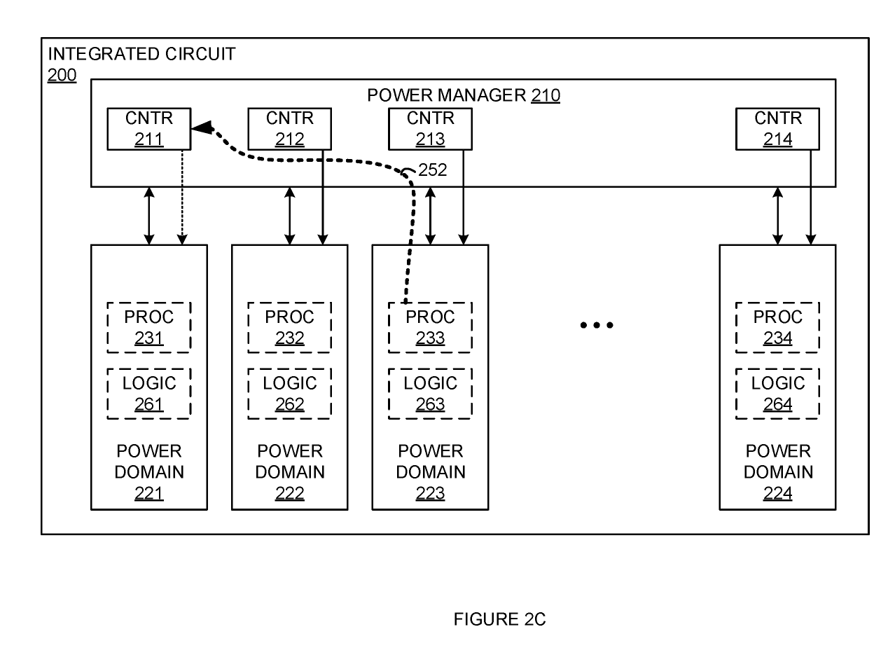

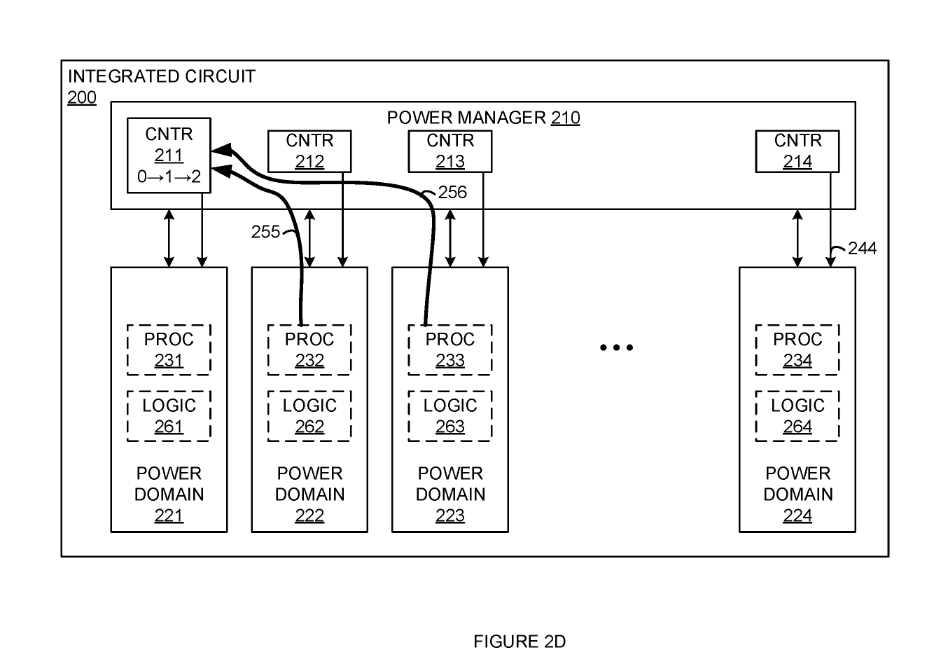

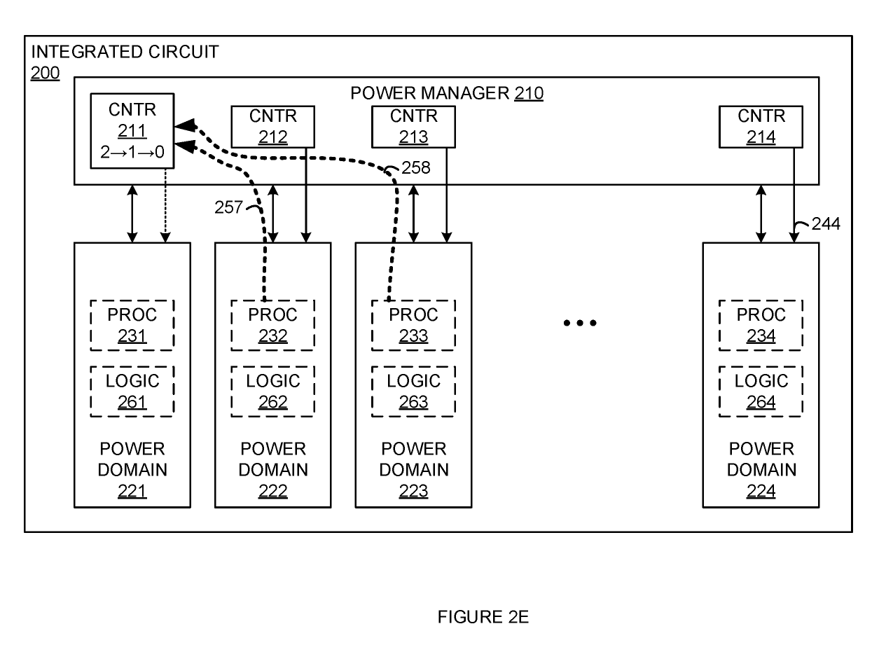

FIGS. 2A-2E illustrate an integrated circuit with multiple power domains that are maintained powered-up based on indicators from other power domains. In FIGS. 2A-2E, integrated circuit 200 includes power manager 210, power domain (PD) 221, power domain 222, power domain 223, and power domain 224. Power manager 210 includes counter 211, counter 212, counter 213, and counter 214. Counter 211 is operatively coupled to power domain 221. Counter 212 is operatively coupled to power domain 222. Counter 213 is operatively coupled to power domain 223. Counter 214 is operatively coupled to power domain 224.

Power domain 221 may include processor 231 and/or logic circuitry 261. Power domain 222 may include processor 232 and/or logic circuitry 262. Power domain 223 may include processor 233 and/or logic circuitry 263. Power domain 224 may include processor 234 and/or logic circuitry 264. Integrated circuit 200 may include additional power domains that are not shown in FIG. 2. Integrated circuit 200 may include a master power domain that includes circuitry that is not to be powered-down. In an example, a master power domain may include power manager 210. Power manager 210 is operatively coupled to power domains 221-224.

Power manager 210 includes a counter 211-214 for each respective power domain 221-224. Each counter 211-214 is part of, or operatively coupled to a power management state machine (not shown in FIGS. 2A-2E.) Based on a counter 211-214 for a corresponding power domain 221-224 being effectively non-zero, power manager 210 does not power-off that respective domain 221-224, even if it is idle. Based on the counter 211-214 being effectively zero, power manager 210 may power-down the corresponding power domain 221-224 (optionally as the result of other conditions being met—e.g., expiration of an idle timer.)

Agents in IC 200 (e.g., processors 231-234) can access (e.g., write or read) a first address to increment the count of a corresponding counter 211-214. In an embodiment, each counter 211-214 is incremented by an access to a unique address associated with that counter 211-214.

For example, processor 233 in power domain 223 may write to a first address (a.k.a. increment address) in order to increment the count in counter 211 and thereby keep power domain 221 from being powered-down. This is illustrated in FIG. 2B by arrow 251. As long as the count in counter 211 is non-zero (or logically equivalent to a non-zero value), power manager 210 will not allow power domain 221 to be powered-down.

Agents in IC 200 (e.g., processors 231-234) can access (e.g., write or read) a second address (different from the first address) to decrement the count of a corresponding counter 211-214. In an embodiment, each counter 211-214 is decremented by an access to a unique address associated with that counter 211-214.

For example, processor 233 in power domain 223 may write to a second address (a.k.a. decrement address) in order to decrement the count in counter 211 and thereby optionally allowing power domain 221 to be powered-down. This is illustrated in FIG. 2C by dashed line arrow 252. If the count in counter 211 reaches zero (or a value logically equivalent to a zero value or other threshold criteria—e.g., value equals or goes past a maximum or minimum count), power manager 210 will allow power domain 221 to be powered-down.

Multiple agents in IC 200 (e.g., processors 231-234) can access (e.g., write or read) the first address to increment the count of the corresponding counter 211-214 and can access the second address to decrement the count of the corresponding counter 211-214. These multiple agents may perform these accesses in any order. The accesses that increment or decrement a counter 211-214 may occur in an atomic manner. An operation acting the counters 211-214 is atomic because it completes in a single step relative to other accesses to the same first and second addresses by power domains 221-224. When an atomic access is performed on a counter 211-214, power manager 210 cannot observe the modification (increment or decrement) half-complete. When power manager 210 reads the value of a counter 211-214, it reads the entire value as it appeared at a single moment in time.

The effect of each increment and decrement is cumulative with respect to the increments and decrements caused by other accesses (e.g., by another power domain 221-224.) For example, processor 232 in power domain 222 may write to the first (i.e., increment) address in order to increment the count in counter 211 and thereby prevent power domain 221 from being powered-down. This is illustrated in FIG. 2D by arrow 255. Processor 233 in power domain 222 may write to the same first (i.e., increment) address in order to increment the count in counter 211 again. This write by processor 233 may occur (at least as far as power manager 210 in concerned) either simultaneously or after the first write by processor 232. This is illustrated in FIG. 2D by arrow 256 and the count value shown in counter 211 transitioning from 0 to 1, and then from 1 to 2.

Continuing the example, processor 232 in power domain 222 may write to the second (i.e. decrement) address in order to decrement the count in counter 211 and thereby optionally allow power domain 221 to be powered-down. This is illustrated in FIG. 2E by dashed line arrow 257. Processor 233 in power domain 222 may write to the same second (i.e. decrement) address in order to decrement the count in counter 211 again. This write by processor 233 may occur (at least as far as power manager 210 in concerned) either simultaneously or after the write by processor 232. This is illustrated in FIG. 2E by dashed line arrow 258 and the count value shown in counter 211 transitioning from 2 to 1, and then from 1 to 0. Thus, it should be understood that the accesses that increment and decrement counters 211-214 may occur in any order, and may come from any power domain 221-224 regardless of the order in which power domains 221-224 increment/decrement, and regardless of how many times a particular power domain has incremented/decremented a counter 211-214. In an embodiment, if a power domain 221-224 decrements a particular counter 211-214 that is already at zero, power manager 210 may consider this event an error and initiate appropriate action (e.g., enter an error recovery routine, initiate exception processing, etc.)

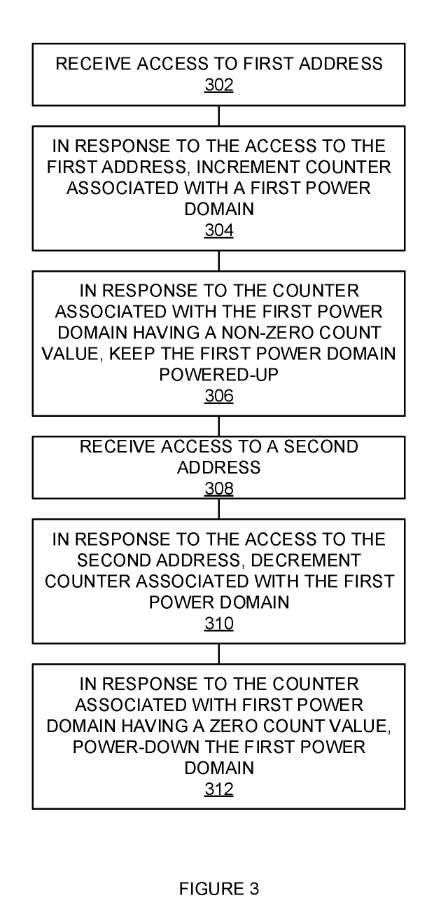

FIG. 3 is a flowchart illustrating a method of maintaining a power domain in a powered-up state. The steps illustrated in FIG. 3 may be performed, for example, by one or more elements of integrated circuit 100, integrated circuit 200, and/or their components. An access to a first address is received (302). For example, power manager 210 may receive, from power domain 222, a write to the increment address for counter 211. The increment address for counter 211 may be in an address range designated as memory-mapped I/O space.

In response to the access to the first address, the counter associated with a first power domain is incremented (304). For example, in response to the write from power domain 222 to the increment address for counter 211, power manager 210 may increment the value in counter 211 from a zero to a one (1). In response to the counter associated with the first power domain having a non-zero count value, the first power domain is kept powered-up (306). For example, in response to the value in counter 211 being a one (or greater), power manager 210 keeps power domain 221 powered-up.

An access to a second address is received (308). For example, power manager 210 may receive, from power domain 222, a write to the decrement address for counter 211. The decrement address for counter 211 may be in an address range designated as memory-mapped I/O space.

In response to the access to the second address, the counter associated with a first power domain is decremented (310). For example, in response to the write from power domain 222 to the decrement address for counter 211, power manager 210 may decrement the value in counter 211 from a one (1) to a zero. In response to the counter associated with the first power domain having a zero count value, the first power domain is powered-down (312). For example, in response to the value in counter 211 being a zero, power manager 210 allows power domain 221 to be powered-down (either immediately or optionally as the result of other conditions/indicators are met.)

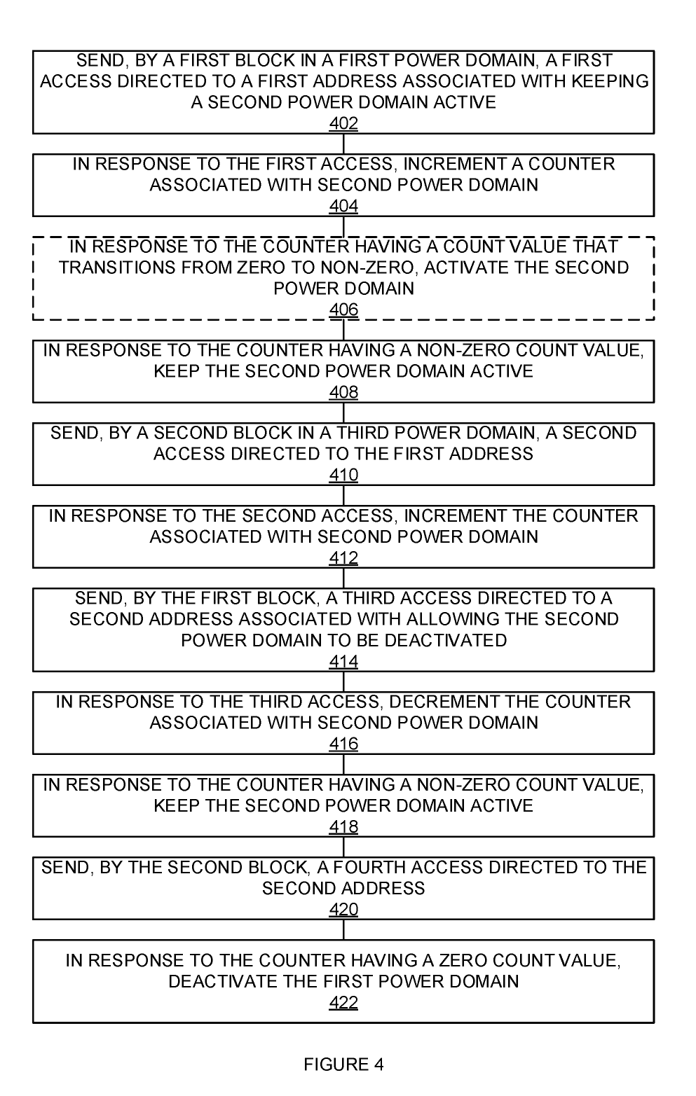

FIG. 4 is a flowchart illustrating a method of activating and deactivating a power domain. The steps illustrated in FIG. 4 may be performed, for example, by one or more elements of integrated circuit 100, integrated circuit 200, and/or their components. By a first block in a first power domain, a first access directed to a first address associated with keeping a second power domain active is sent (402). For example, processor 231 in power domain 221 may send a write access directed to the increment address of counter 212. In response to the first access, a counter associated with the second power domain is incremented (404). For example, in response to the write access directed to the increment address of counter 212, counter 212 may be incremented.

If appropriate, in response to the counter having a count value that transitions from a zero value to a non-zero value, the second power domain is activated (406). For example, if the count value in counter 212 starts at zero, the second power domain will be activated by power manager 210 in response to the value in counter 212 being incremented from a zero to a one. In response to the counter having a non-zero count value, the second power domain is kept active (408). For example, in response to the value in counter 212 being a one (or greater), power manager 210 keeps power domain 222 powered-up.

By a second block in a third power domain, a second access directed to the first address is sent (410). For example, processor 233 in power domain 223 may send a write access directed to the increment address of counter 212. In response to the second access, a counter associated with the second power domain is incremented (412). For example, in response to the second write access directed to the increment address of counter 212, counter 212 may be incremented from a 1 to a 2.

By the first block, a third access directed to a second address associated with allowing the second power domain to be deactivated is sent (414). For example, processor 231 in power domain 221 may send a write access directed to the decrement address of counter 212. In response to the third access, the counter associated with the second power domain is decremented (416). For example, in response to the write access directed to the decrement address of counter 212, counter 212 may be decremented from 2 to 1.

In response to the counter having a non-zero count value, the second power domain is kept active (418). For example, in response to the value in counter 212 being a one, power manager 210 keeps power domain 222 powered-up.

By the second block, a fourth access directed to the second address is sent (420). For example, processor 233 in power domain 223 may send a write access directed to the decrement address of counter 212. In response to the fourth write access, counter 212 may be decremented from a 1 to a zero. In response to the counter having a zero count value, the first power domain is deactivated (422). For example, in response to the value in counter 212 reaching a zero, power manager 210 allows power domain 222 to be powered-down (either immediately or as a result of other conditions/indicators are met.)

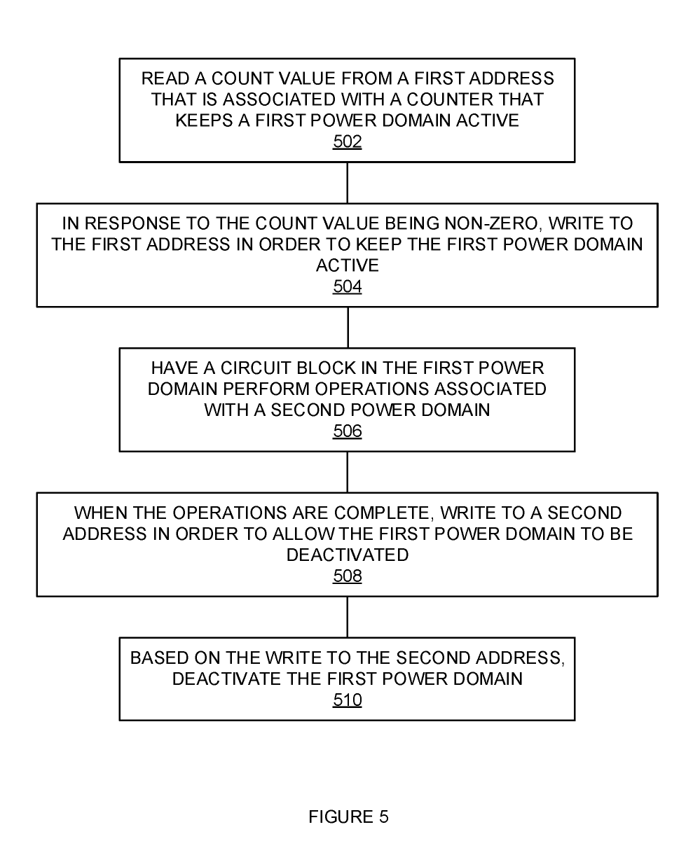

FIG. 5 is a flowchart illustrating a method of allowing a power domain to be deactivated. The steps illustrated in FIG. 5 may be performed, for example, by one or more elements of integrated circuit 100, integrated circuit 200, and/or their components. A count value is read from a first address that is associated with a counter that keeps a first power domain active (502). For example, processor 232 in power domain 222 may read a first address (e.g., the increment or decrement address) that is associated with counter 211.

In response to the count value being non-zero, the first address is written in order to keep the first power domain active (504). For example, in response to receiving a non-zero count value from counter 211, processor 232 may write to the increment address of counter 211 in order to keep power domain 221 powered-up.

A circuit block in the first power domain performs operations associated with a second power domain (506). For example, a circuit in power domain 221 (e.g., processor 231) may perform operations that send and/or receive data to/from power domain 222. After the operations are complete, a second address is written to in order to allow the first power domain to be deactivated (508). For example, after power domain 221 is done performing operations for power domain 222, power domain 222 may write to the decrement address of counter 211.

Based on the write to the second address, the first power domain is deactivated (510). For example, based on the write by power domain 222 to counter 211's decrement address, power domain 221 may be powered-down (either immediately or as a result of other conditions/indicators being met.)

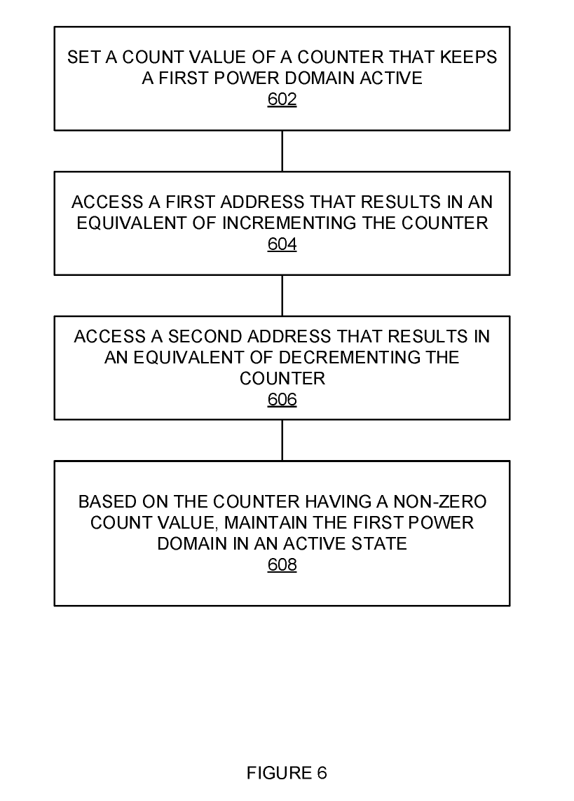

FIG. 6 is a flowchart illustrating a method of keeping a power domain active. The steps illustrated in FIG. 6 may be performed, for example, by one or more elements of integrated circuit 100, integrated circuit 200, and/or their components. A count value of a counter that keeps a first power domain active is set (602). For example, upon the initialization of integrated circuit 100 and/or power domain 221, the count value of counter 211 may be set to a non-zero value.

An access is made to a first address that results in an equivalent of an incrementing of the counter (604). For example, processor 232 in power domain 222 may access the increment address for counter 211. As a result, an operation equivalent to incrementing counter 211 results. For example, if counter 211 uses thermometer coding, an additional bit may be set in counter 211 (even though this results in the value of counter 211 changing by a power of 2.)

An access is made to a second address that results in an equivalent of an decrementing of the counter (606). For example, processor 232 in power domain 222 may access the decrement address for counter 211. As a result, an operation equivalent to decrementing counter 211 results. For example, if counter 211 uses thermometer coding, an additional bit may be unset in counter 211 (even though this results in the value of counter 211 changing by a power of 2.)

Based on the counter having a non-zero count value, the first power domain is maintained in an active state (608). For example, based on any bits in counter 211 being set (e.g., the least significant bit of a thermometer or other code), power manager 210 will maintain power domain 221 in a powered-up state.

The methods, systems and devices described herein may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of integrated circuit 100, and/or integrated circuit 200, and their components. These software descriptions may be: behavioral, register transfer, logic component, transistor, and layout geometry-level descriptions.

Data formats in which such descriptions may be implemented are stored on a non-transitory computer readable medium include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Physical files may be implemented on non-transitory machine-readable media such as: 4 mm magnetic tape, 8 mm magnetic tape, 3½-inch floppy media, CDs, DVDs, hard disk drives, solid-state disk drives, solid-state memory, flash drives, and so on.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), multi-core processors, graphics processing units (GPUs), etc.

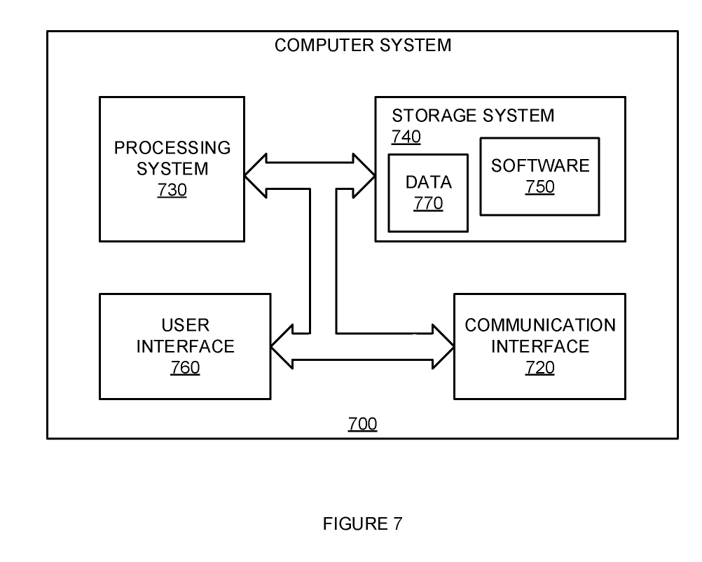

FIG. 7 illustrates a block diagram of an example computer system. In an embodiment, computer system 700 and/or its components include circuits, software, and/or data that implement, or are used to implement, the methods, systems and/or devices illustrated in the Figures, the corresponding discussions of the Figures, and/or are otherwise taught herein. In particular, processing system 730 of computer system 700 may be a processor core that runs software 750 to control signals coupled between communication interface 720 and at least power domains 121-124, 221-224 in order to implement the functions of at least power manager 110 and power manager 210.

Computer system 700 includes communication interface 720, processing system 730, storage system 740, and user interface 760. Processing system 730 is operatively coupled to storage system 740. Storage system 740 stores software 750 and data 770. Processing system 730 is operatively coupled to communication interface 720 and user interface 760. Processing system 730 may be an example of one or more of integrated circuit 100, integrated circuit 200, and/or their components.

Computer system 700 may comprise a programmed general-purpose computer. Computer system 700 may include a microprocessor. Computer system 700 may comprise programmable or special purpose circuitry. Computer system 700 may be distributed among multiple devices, processors, storage, and/or interfaces that together comprise elements 720-770.

Communication interface 720 may comprise a network interface, modem, port, bus, link, transceiver, or other communication device. Communication interface 720 may be distributed among multiple communication devices. Processing system 730 may comprise a microprocessor, microcontroller, logic circuit, or other processing device. Processing system 730 may be distributed among multiple processing devices. User interface 760 may comprise a keyboard, mouse, voice recognition interface, microphone and speakers, graphical display, touch screen, or other type of user interface device. User interface 760 may be distributed among multiple interface devices. Storage system 740 may comprise a disk, tape, integrated circuit, RAM, ROM, EEPROM, flash memory, network storage, server, or other memory function. Storage system 740 may include computer readable medium. Storage system 740 may be distributed among multiple memory devices.

Processing system 730 retrieves and executes software 750 from storage system 740. Processing system 730 may retrieve and store data 770. Processing system 730 may also retrieve and store data via communication interface 720. Processing system 750 may create or modify software 750 or data 770 to achieve a tangible result. Processing system may control communication interface 720 or user interface 760 to achieve a tangible result. Processing system 730 may retrieve and execute remotely stored software via communication interface 720.

Software 750 and remotely stored software may comprise an operating system, utilities, drivers, networking software, and other software typically executed by a computer system. Software 750 may comprise an application program, applet, firmware, or other form of machine-readable processing instructions typically executed by a computer system. When executed by processing system 730, software 750 or remotely stored software may direct computer system 700 to operate as described herein.

Implementations discussed herein include, but are not limited to, the following examples:

### EXAMPLE 1

An integrated circuit, comprising: a plurality of electronic components organized as at least two power domains, the at least two power domains including a first power domain and a second power domain; and, a power management unit to, based on a first indicator received from the second power domain, maintain the first power domain in a powered-up state.

### EXAMPLE 2

The integrated circuit of example 1, wherein the power management unit is in the second power domain.

### EXAMPLE 3

The integrated circuit of example 1, wherein the power management unit includes a first register that holds a first value associated with the first power domain, the first value being changed in a first way in response to the first indicator, the first value being changed in a second way that undoes the first way in response to a received second indicator.

### EXAMPLE 4

The integrated circuit of example 3, wherein the first way is equivalent to incrementing the first value and the second way is equivalent to decrementing the first value.

### EXAMPLE 5

The integrated circuit of example 3, wherein the second indicator is received from the second power domain.

### EXAMPLE 6

The integrated circuit of example 3, wherein the second indicator is received from a third power domain of the at least two power domains.

### EXAMPLE 7

The integrated circuit of example 3, wherein the power management unit places the first power domain in a powered-down state based at least in part on the second way causing the first value to meet a first threshold criteria.

### EXAMPLE 8

The integrated circuit of example 3, wherein the first value is change in the first way based on a first access to a first address by a first processor and the first value is changed in the second way based on a second access to a second address.

### EXAMPLE 9

An integrated circuit, comprising: a plurality of electronic logic blocks organized into at least three power domains, the at least three power domains including a first power domain, a second power domain, and a master power domain; and, a power management unit that is part of the master power domain, the power management unit to maintain a value that changes, in a first way, based at least in part on a first plurality of accesses by the first power domain, the value to change, in a second way, based at least in part on a second plurality of accesses by the first power domain, the power management unit to maintain the second power domain in a powered-up state based at least in part on the value meeting a threshold criteria.

### EXAMPLE 10

The integrated circuit of example 9, wherein the first way is equivalent to incrementing the value and the second way is equivalent to decrementing the value.

### EXAMPLE 11

The integrated circuit of example 10, wherein the threshold criteria is equivalent to the value being equal to a predetermined number.

### EXAMPLE 12

The integrated circuit of example 11, wherein based at least in part on the value being equal to the predetermined number and the power management unit receiving a one of the second plurality of accesses, the power management unit produces an indication of an error condition.

### EXAMPLE 13

The integrated circuit of example 9, wherein the first plurality of accesses correspond to accesses to a first address and the second plurality of accesses correspond to accesses to a second address.

### EXAMPLE 14

The integrated circuit of example 9, wherein the at least two power domains includes a third power domain, and the value is to change, in the first way, in response to a third plurality of accesses by the third power domain, the value to also change, in the second way, in response to fourth second plurality of accesses by the third power domain.

### EXAMPLE 15

The integrated circuit of example 14, wherein the third plurality of accesses correspond to accesses to the first address and the fourth plurality of accesses correspond to accesses to the second address.

### EXAMPLE 16

A method of managing a plurality of power domains, comprising: accessing a first address that results in an equivalent of incrementing a counter; and, accessing a second address that results in an equivalent of decrementing the counter, a value of the counter to determine whether a first power domain of a plurality of power domains is to be maintained in a powered-up state.

### EXAMPLE 17

The method of example 16, wherein the access to the first address is received from a second power domain of the plurality of power domains.

### EXAMPLE 18

The method of example 17, wherein the access to the second address is received from a third power domain of the plurality of power domains.

### EXAMPLE 19

The method of example 16, wherein based at least in part on the value of the counter being equivalent to a non-zero value, the first power domain is maintained in a powered-up state.

### EXAMPLE 20

The method of example 16, wherein the first address and the second address are in a memory-mapped I/O address range.

The foregoing descriptions of the disclosed embodiments have been presented for purposes of illustration and description. They are not intended to be exhaustive or to limit the scope of the claimed subject matter to the precise form(s) disclosed, and other modifications and variations may be possible in light of the above teachings. The embodiments were chosen and described in order to best explain the principles of the disclosed embodiments and their practical application to thereby enable others skilled in the art to best utilize the various embodiments and various modifications as are suited to the particular use contemplated. It is intended that the appended claims be construed to include other alternative embodiments except insofar as limited by the prior art.

What is claimed is:

1. An integrated circuit, comprising:
a plurality of electronic components organized as at least two power domains, the at least two power domains including a first power domain and a second power domain; and,
a power management unit to, based on a first indicator received from the second power domain, maintain the first power domain in a powered-up state.

2. The integrated circuit of claim 1, wherein the power management unit is in the second power domain.

3. The integrated circuit of claim 1, wherein the power management unit includes a first register that holds a first value associated with the first power domain, the first value being changed in a first way in response to the first indicator, the first value being changed in a second way that undoes the first way in response to a received second indicator.

4. The integrated circuit of claim 3, wherein the first way is equivalent to incrementing the first value and the second way is equivalent to decrementing the first value.

5. The integrated circuit of claim 3, wherein the second indicator is received from the second power domain.

6. The integrated circuit of claim 3, wherein the second indicator is received from a third power domain of the at least two power domains.

7. The integrated circuit of claim 3, wherein the power management unit places the first power domain in a powered-down state based at least in part on the second way causing the first value to meet a first threshold criteria.

8. The integrated circuit of claim 3, wherein the first value is change in the first way based on a first access to a first address by a first processor and the first value is changed in the second way based on a second access to a second address.

9. An integrated circuit, comprising:
a plurality of electronic logic blocks organized into at least three power domains, the at least three power domains including a first power domain, a second power domain, and a master power domain; and,
a power management unit that is part of the master power domain, the power management unit to maintain a value that changes, in a first way, based at least in part on a first plurality of accesses by the first power domain, the value to change, in a second way, based at least in part on a second plurality of accesses by the first power domain, the power management unit to maintain the second power domain in a powered-up state based at least in part on the value meeting a threshold criteria.

10. The integrated circuit of claim 9, wherein the first way is equivalent to incrementing the value and the second way is equivalent to decrementing the value.

11. The integrated circuit of claim 10, wherein the threshold criteria is equivalent to the value being equal to a predetermined number.

12. The integrated circuit of claim 11, wherein based at least in part on the value being equal to the predetermined number and the power management unit receiving a one of the second plurality of accesses, the power management unit produces an indication of an error condition.

13. The integrated circuit of claim 9, wherein the first plurality of accesses correspond to accesses to a first address and the second plurality of accesses correspond to accesses to a second address.

14. The integrated circuit of claim 9, wherein the at least two power domains includes a third power domain, and the value is to change, in the first way, in response to a third plurality of accesses by the third power domain, the value to also change, in the second way, in response to fourth second plurality of accesses by the third power domain.

15. The integrated circuit of claim 14, wherein the third plurality of accesses correspond to accesses to the first address and the fourth plurality of accesses correspond to accesses to the second address.

16. A method of managing a plurality of power domains, comprising:
accessing a first address that results in an equivalent of incrementing a counter; and,
accessing a second address that results in an equivalent of decrementing the counter, a value of the counter to determine whether a first power domain of a plurality of power domains is to be maintained in a powered-up state.

17. The method of claim 16, wherein the access to the first address is received from a second power domain of the plurality of power domains.

18. The method of claim 17, wherein the access to the second address is received from a third power domain of the plurality of power domains.

19. The method of claim 16, wherein based at least in part on the value of the counter being equivalent to a non-zero value, the first power domain is maintained in a powered-up state.

20. The method of claim 16, wherein the first address and the second address are in a memory-mapped I/O address range.
